(19) United States
(12) Patent Application Publication
(10) Pub. No.: US 2010/0283240 A1
(43) Pub. Date: Nov. 11, 2010

(54) EXTERNALLY REPLACEABLE VACUUM CHAMBER TO CHAMBER FLANGE SEAL

(75) Inventor: HANS PETER THEODORUS CEELEN, Rio Vista, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/435,580

(22) Filed: May 5, 2009

(51) Int. Cl. F16L 19/025

(52) U.S. Cl. 285/379

(57) ABSTRACT

A chamber interface sealing assembly includes first and second chambers with respective first and second mating walls disposed adjacent each other. The first and second mating walls have respective through holes, which are aligned to form a passage interconnecting the first and second chambers. A first flange extends outwardly from the first mating wall and away from the passage. A second flange extends outwardly from the second mating wall and away from the passage. The first and second flanges define a circumferential concave groove therebetween. A close-loop gasket is disposed within the circumferential concave groove.

### BACKGROUND OF THE INVENTION

1. Field of the Invention

Embodiments disclosed herein generally relate to a chamber interface sealing assembly. More specifically, the embodiments relate to a chamber interface sealing assembly for a continuous chamber system.

2. Description of the Related Art

O-ring seals when used to provide air tight seals for vacuum chambers are subject to losing vacuum integrity due to damage or eventual deterioration of O-rings. The current practice of sealing flanges between two adjacent vacuum chambers is to secure O-rings inside an internal groove therebetween. It is very difficult to remove and replace O-rings unless the two adjacent vacuum chambers are spaced apart sufficiently from each other to allow the O-rings to be accessed. In an in-line continuous chamber system, there may be as many as forty vacuum chambers coupled together. It is difficult to move any of the vacuum chambers to access O-rings therebetween without moving each of the chambers. When the vacuum chambers are large area vacuum chambers, moving the chambers can be even more difficult.

In particular, any chambers between other adjacent chambers are not simply lifted and then slid out from its position between its adjacent chambers. The adjacent chambers are moved to provide clearance such that numerous chambers are idle for replacing O-rings, thereby impacting the throughput of the processing line. For the forgoing reasons, there is a need for improving sealing flange designs between two adjacent vacuum chambers.

### SUMMARY OF THE INVENTION

According to one aspect of the present invention, a chamber interface sealing assembly includes first and second chambers respectively having first and second mating walls disposed adjacent each other. The first and second mating walls have respective through holes, which are aligned to form a passage interconnecting the first and second chambers. A first flange extends outwardly from the first mating wall and away from the passage. The first flange has a first wall and a first ledge extending substantially perpendicular to the first wall. A second flange extends outwardly from the second mating wall and away from the passage. The second flange has a second wall and a second ledge extending substantially perpendicular to the second wall. The first and second flanges define a circumferential concave groove therebetween bound by the first ledge, second ledge, first wall and second wall. A close-loop gasket is disposed within the circumferential concave groove.

In another aspect, a chamber interface sealing assembly includes first and second chambers respectively having first and second mating walls disposed adjacent each other. The first and second mating walls have respective through holes, which are aligned to form a passage interconnecting the first and second chambers. A first flange extends outwardly from the first mating wall and away from the passage. The first flange has a first wall and a first ledge extending substantially perpendicular to the first wall. A second flange extends outwardly from the second mating wall and away from the passage. The second flange has a second wall and a second ledge extending substantially perpendicular to the second wall. The first and second flanges define a circumferential concave groove therebetween bound by the first ledge, second ledge, first wall and second wall. A first pair of beveled corners are disposed respectively between outer surfaces of both the first ledge and the second ledges and inner surfaces of the circumferential concave groove. A second pair of beveled corners are disposed respectively on the first and second walls, and at a bottom of the circumferential concave groove. A close-loop gasket is disposed within the circumferential concave groove.

In another aspect, a method for replacing a gasket of a chamber interface sealing assembly includes the following steps. A first gasket is removed from a circumferential concave groove defined between first and second flanges, which respectively extend outwardly from first and second mating walls of first and second chambers. The first flange has a first wall and a first ledge extending substantially perpendicular to the first wall. The second flange has a second wall and a second ledge extending substantially perpendicular to the second wall. The first and second flanges define a circumferential concave groove therebetween bound by the first ledge, second ledge, first wall and second wall. A second gasket is placed into the circumferential concave groove and two opposite ends of the second gasket are connected so as to form a close-loop gasket. A vacuum is drawn in one or more of the first and second chambers so as to pull the close-loop gasket into the circumferential concave groove to seal the first and second chambers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a cross-sectional view of a continuous chamber system according to one embodiment.

FIG. 2 illustrates an enlarged view of a chamber interface sealing assembly according to one embodiment.

FIG. 3 illustrates an enlarged view of a chamber interface sealing assembly according to another embodiment.

FIG. 4A illustrates an open-loop gasket according to one embodiment.

FIG. 4B illustrates a close-loop gasket according to another embodiment.

FIG. 5A and FIG. 5B illustrates a close-loop gasket being pulled into a concave groove according to one embodiment.

### DETAILED DESCRIPTION

Embodiments disclosed herein are generally directed to a chamber interface sealing assembly for a continuous chamber system consisting of a series of connected giant vacuum chambers.

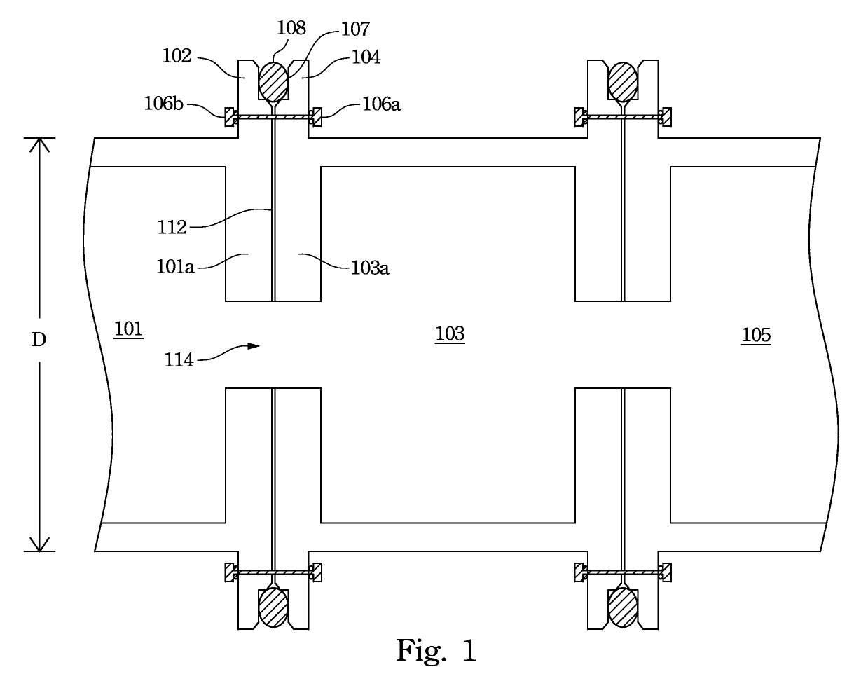

FIG. 1 illustrates a cross-sectional view of a continuous chamber system according to one embodiment. Only three chambers (101, 103, 105) are exemplarily illustrated to be continuously interconnected in FIG. 1, but there may be several more to be continuously interconnected. Additionally, while description will be made in reference to large area substrate processing chambers, it is to be understood that the embodiments discussed herein are applicable to processing chambers of any size. Suitable processing chambers may be purchased from Applied Materials, Inc., Santa Clara, Calif., but it is to be understood that the embodiments disclosed herein have applicability with other processing chambers produced by other manufacturers as well.

Each of the chambers (101, 103, 105) is a large area substrate vacuum chamber, e.g. a side (D) of which may be more than 1 meter or sized to permit passage of a substrate having a surface area of about 1 square meter or greater. Any two neighboring chambers such as chambers (101, 103) may have their respective mating walls such as walls (101a, 103a) disposed adjacent each other. Two mating walls (101a, 103a) have respective through holes, which are aligned to form a passage 114 interconnecting the chambers (101, 103). The passage 114 allows substrates to be transported therethrough. The mating walls (101a, 103a) may be of rectangular, circular or other shapes. A flange 102 extends outwardly from the mating wall 101a and away from the passage 114 while the other flange 104 extends outwardly from the mating wall 103a and away from the passage 114. The two flanges (102, 104) may be coupled together. In one embodiment, the two flanges 102, 104 are screwed together using a bolt 106a and a nut 106b, i.e. the bolt 106a extends through two flanges 102, 104 and coupled with the nut 106b, to couple the adjacent chambers 101, 103 to each other. The mating walls (101a, 103a) may be spaced apart from each other to form a gap 112 therebetween. An external circumferential concave groove 107 is defined between two flanges (102, 104) such that a close-loop gasket 108, e.g. an O-ring, can be placed within and seal the interface 112. Since the concave groove 107 is external, the close-loop gasket 108 may be easily accessed during removal or replacement without having the need to move the two neighboring chambers (101, 103).

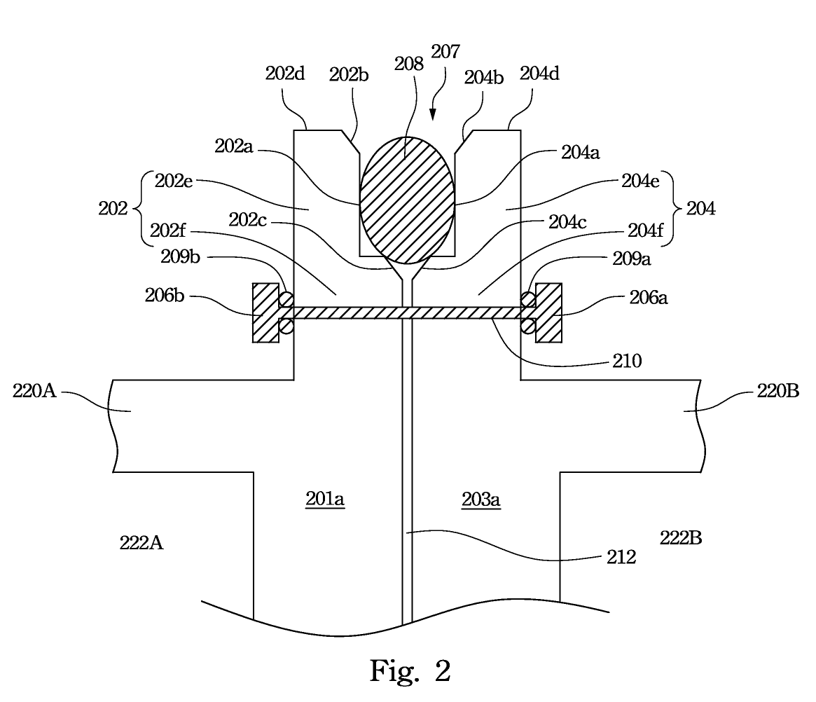

FIG. 2 illustrates an enlarged view of a chamber interface sealing assembly according to one embodiment. In this detailed view, two flanges (202, 204) are coupled together using a bolt 206a and a nut 206b to secure a gasket 208 therebetween. Gaskets (209a, 209b) may be added to airtight seal a screw hole 210, through which the bolt 206a is inserted. Each flange (204, 204) may be divided into two parts: a wall (202f, 204f) and a ledge (202e, 204e), both of which are outside of the outer walls 220A, 220B of the chambers 222A, 222B. The ledge (202e, 204e) is narrower than the wall (202f, 204f), and extends substantially perpendicular to the wall (202f, 204f). A concave groove 207 is defined between the two flanges (202, 204), that is, the concave groove 207 is bound by the ledge 202e, ledge 204e, wall 202f and wall 204f. Beveled corners (202b, 204b) may be formed between outer surfaces (202d, 204d) of respective flanges (202, 204) and inner surfaces (202a, 204a) of the concave groove 207, i.e. beveled corners (202b, 204b) are jointed corners between outer surfaces of respective flanges (202, 204) and inner surfaces (202a, 204a) of the concave groove 207. Beveled corners (202b, 204b) permit the close-loop gasket 208 to be easily placed or pulled into the concave groove 207. Beveled corners (202c, 204c) may be formed at a bottom of the concave groove 207 and are in close contact with the close-loop gasket 208 so as to achieve an airtight seal. In this embodiment, a gap 212 may be left between two mating walls (201a, 203a) such that two mating walls (201a, 203a) would not directly lean against each other and generate particles. In an alternate embodiment, the gap 212 may be sufficiently large to provide clearance for any of adjacent chambers to be lifted and slid out from its position for retooling or reconfiguring to accommodate future upgrades or hardware advances.

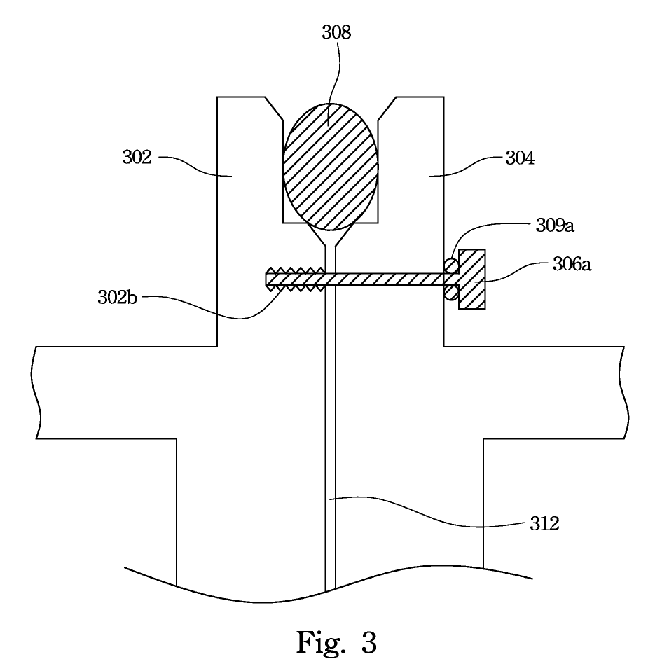

FIG. 3 illustrates an enlarged view of a chamber interface sealing assembly according to another embodiment. In this embodiment, two flanges (302, 304) are screwed together in a manner slightly different from the embodiment in FIG. 2. In particular, a nut 206b (as illustrated in FIG. 2) is eliminated, and a threaded hole 302b is added. A bolt 306a is fed through the flange 304 and screwed into the threaded hole 302b of the flange 302 to fasten two flanges (302, 304) and the gasket 308 therebetween. Thus, fewer though holes, e.g. the hole through which a bolt is inserted, are connected to the gap 312 and fewer gaskets 309a are needed (compared with the embodiment in FIG. 2), thereby reducing the possibility of breaking the vacuum integrity.

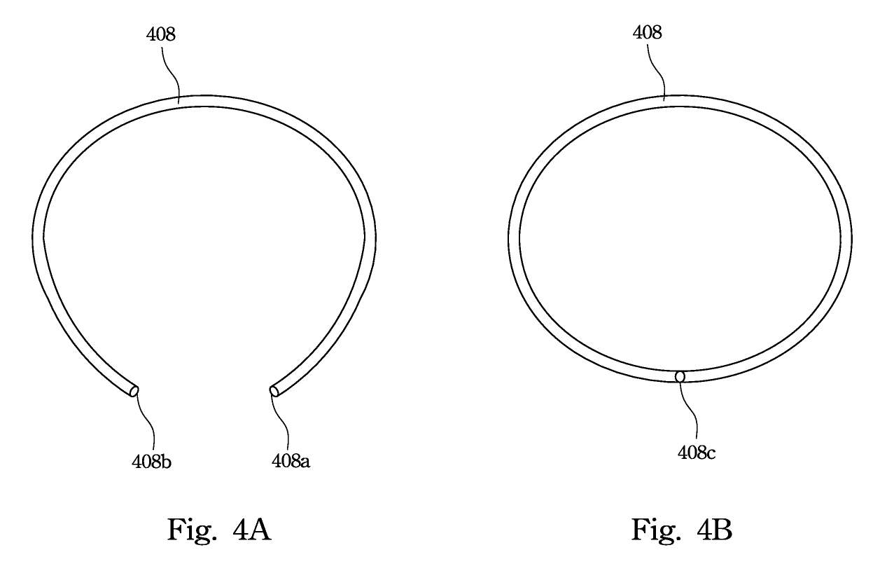

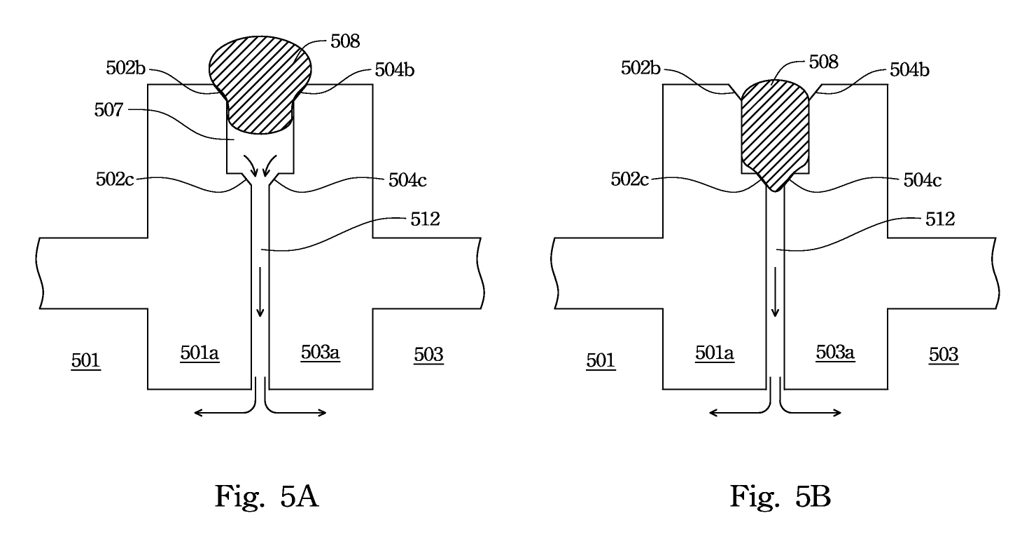

FIG. 4A illustrates an open-loop gasket while FIG. 4B illustrates a close-loop gasket. The open-loop gasket 408 may have its two opposite ends (408a and 408b) interconnected by fusing or gluing them together after the open-loop gasket 408 is placed into a concave groove such as illustrated in FIG. 5A. That is, the two opposite ends (408a and 408b) may be fused to form a fused connection part 408c or glued (by an adhesive) to form a glued connection part 408c.

FIG. 5A and FIG. 5B illustrate a close-loop gasket being pulled into a concave groove according to one embodiment. Consumable gaskets are typically replaced before leaks begin to impact processing environment, e.g. a vacuum integrity. Before pulling a new gasket 518 into a concave groove 507, a deteriorated gasket, i.e. a gasket no longer provides a vacuum tight seal, should be removed from the concave groove 507 first. The deteriorated close-loop gasket may be cut into an open-loop gasket (such as an open-loop gasket 408 in FIG. 4A) so that it is easily pulled out from the continuous chamber system. A new open-loop gasket (such as an open-loop gasket 408 in FIG. 4A) with two opposite ends (such as ends 408a and 408b in FIG. 4A) is then placed into the concave groove 507. After a new open-loop gasket 518 is in place adjacent beveled edges (502b, 504b), two opposite ends thereof are connected, then a vacuum is drawn in one or more chambers (501, 503) to pull the new open-loop gasket 518 into the concave groove 507. The air within the gap 512 between two mating walls (501a, 503a) would flow along directions indicated by the arrows in FIG. 5A and FIG. 5B. The vacuum is maintained continuously in one or more chambers (501, 503) until the new close-loop gasket 518 is fully in contact with the beveled corners (502c, 504c) as illustrated in FIG. 5B. In this embodiment, the gap 512 serves another purpose as a vacuum channel to pull the new open-loop gasket 518 further into the concave groove 507. This embodiment provides a rapid, convenient way to secure the gasket 518 to the desired position of airtight sealing.

According to discussed embodiments, the improved chamber interface sealing assembly allows a gasket seal to be replaceable on site without moving its two neighboring chambers. In addition, an improved way of replacing gasket is accompanied by new designs of the improved chamber interface sealing assembly to rapidly secure the gasket to be airtight.

While the foregoing is directed to embodiments of the present invention, other and further embodiments of the invention may be devised without departing from the basic scope thereof, and the scope thereof is determined by the claims that follow.

1. A chamber interface sealing assembly comprising:
first and second chambers respectively having first and second mating walls disposed adjacent each other, the first and second mating walls having respective through holes, which are aligned to form a passage interconnecting the first and second chambers;
a first flange extending outwardly from the first mating wall and away from the passage, the first flange having a first wall and a first ledge extending substantially perpendicular to the first wall;
a second flange extending outwardly from the second mating wall and away from the passage, the second flange having a second wall and a second ledge extending substantially perpendicular to the second wall, the first and second flanges defining a circumferential concave groove therebetween bound by the first ledge, second ledge, first wall and second wall; and
a close-loop gasket disposed within the circumferential concave groove.

2. The chamber interface sealing assembly of claim 1, wherein the first and second chambers are respectively sized to permit passage of a substrate having a surface area of about 1 square meter or greater.

3. The chamber interface sealing assembly of claim 2, wherein the first and second ledges have respective first beveled corners between outer surfaces thereof and inner surfaces of the circumferential concave groove.

4. The chamber interface sealing assembly of claim 3, wherein the first and second walls have respective second beveled corners at a bottom of the circumferential concave groove.

5. The chamber interface sealing assembly of claim 2, wherein the first and second walls have respective second beveled corners at a bottom of the circumferential concave groove.

6. The chamber interface sealing assembly of claim 2, wherein the first and second walls are screwed together to secure the close-loop gasket disposed within the circumferential concave groove.

7. The chamber interface sealing assembly of claim 1, wherein the first and second walls are screwed together to secure the close-loop gasket disposed within the circumferential concave groove.

8. The chamber interface sealing assembly of claim 1, wherein the first and second mating walls are spaced apart from each other to form a gap therebetween.

9. The chamber interface sealing assembly of claim 1, wherein the first and second ledges have respective first beveled corners between outer surfaces thereof and inner surfaces of the circumferential concave groove.

10. The chamber interface sealing assembly of claim 1, wherein the first and second walls have respective second beveled corners at a bottom of the circumferential concave groove.

11. A method for replacing a gasket of a chamber interface sealing assembly, comprising:
removing a first gasket from a circumferential concave groove defined between first and second flanges, which respectively extend outwardly from first and second mating walls of first and second chambers, the first flange having a first wall and a first ledge extending substantially perpendicular to the first wall, the second flange having a second wall and a second ledge extending substantially perpendicular to the second wall, and the circumferential concave groove is bound by the first ledge, second ledge, first wall and second wall;
placing a second gasket into the circumferential concave groove and connecting two opposite ends of the second gasket so as to form a close-loop gasket; and
drawing a vacuum in one or more of the first and second chambers so as to pull the close-loop gasket into the circumferential concave groove to seal the first and second chambers without moving the chambers.

12. The method of claim 11, further comprising:
fusing or gluing the two opposite ends of the second gasket to form the close-loop gasket; and
screwing the first and second flanges together to secure the close-loop gasket disposed within the circumferential concave groove.

13. The method of claim 12, wherein a gap is present between the first and second mating walls after drawing the vacuum.

14. A chamber interface sealing assembly comprising:
a first and second chambers respectively having a first and second mating walls disposed adjacent each other, the first and second mating walls have respective through holes, which are aligned to form a passage interconnecting the first and second chambers;
a first flange extending outwardly from the first mating wall and away from the passage, the first flange having a first wall and a first ledge extending substantially perpendicular to the first wall;
a second flange extending outwardly from the second mating wall and away from the passage, the second flange having a second wall and a second ledge extending substantially perpendicular to the second wall, the first and second flanges defining a circumferential concave groove therebetween bound by the first ledge, second ledge, first wall and second wall;
a first pair of beveled corners disposed respectively between outer surfaces of both the first ledge and the second ledges and inner surfaces of the circumferential concave groove;
a second pair of beveled corners disposed respectively on the first and second walls, and at a bottom of the circumferential concave groove; and
a close-loop gasket disposed within the circumferential concave groove.

15. The chamber interface sealing assembly of claim 14, wherein the first and second chambers are respectively sized to permit passage of a substrate having a surface area of about 1 square meter or greater.

16. The chamber interface sealing assembly of claim 14, further comprising:
a bolt extending through the first and second flanges; and
a nut coupled to the bolt.

17. The chamber interface sealing assembly of claim 16, further comprising two second close-loop gaskets respectively associated with the bolt and the nut to seal the leakage.

18. The chamber interface sealing assembly of claim 14, further comprising a bolt disposed through the first flange and into a threaded hole of the second flange.

19. The chamber interface sealing assembly of claim 18, further comprising a second close-loop gasket associated with the bolt to seal the leakage.

20. The chamber interface sealing assembly of claim 14, wherein the close-loop gasket is in contact with the second pair of beveled corners.
